(19) United States
(12) Patent Application Publication
(10) Pub. No.: US 2017/0336803 A1
(43) Pub. Date: Nov. 23, 2017

(54) AUTOMATED FLIGHT CONTROL SYSTEM WITH ALTITUDE-BASED, AUTOMATICALLY-ADJUSTING RATE OF CLIMB

(71) Applicant: HONEYWELL INTERNATIONAL INC., Morris Plains, NJ (US)

(72) Inventors: Kevin Michael Crozier, Albuquerque, NM (US); David Gribble, Rio Rancho, NM (US); Justin Ryan, Albuquerque, NM (US)

(73) Assignee: HONEYWELL INTERNATIONAL INC., Morris Plains, NJ (US)

(21) Appl. No.: 15/157,531

(22) Filed: May 18, 2016

(51) Int. Cl. G05D 1/04; B64C 9/00; B64C 13/18; B64D 43/00

(52) U.S. Cl. CPC G05D 1/042; B64D 43/00; B64C 9/00; B64C 13/18

(57) ABSTRACT

A method and system of automatically controlling the vertical speed of an aircraft during a climb from a first altitude to a second altitude includes the steps of receiving an input to climb to the second altitude at a first vertical speed; causing the aircraft to climb at the first vertical speed; determining a threshold altitude, wherein the threshold altitude is above the first altitude but below the second altitude, and further determining a reduced vertical speed associated with the threshold altitude, wherein the reduced vertical speed is less than the first vertical speed; monitoring the altitude of the aircraft as is climbs at the first vertical speed from the first altitude towards the threshold altitude; and upon reaching the threshold altitude, causing the aircraft to climb at the reduced vertical speed.

### TECHNICAL FIELD

The present disclosure generally relates to aircraft automated flight control system (AFCS) technologies. More particularly, the present disclosure relates to AFCS technologies with altitude-based, automatically-adjusting rate of climb algorithms and controls.

### BACKGROUND

The automated flight control system (AFCS), or “autopilot”, is a popular feature implemented in many aircraft. Many automated flight control systems for small aircraft provide attitude stabilization and minimal maneuver capability. Such systems may also include an altitude preselect function. Altitude preselect is one of a number of very convenient flight path control functions found in some automated flight control systems. It permits the pilot to preselect a desired flying altitude, then to put the aircraft into a climb or descent to achieve this altitude. When the desired altitude is approached, the altitude present function captures the aircraft at the desired altitude and holds it there.

Some aircraft automated flight control systems may include a vertical speed mode in connection with the above-noted altitude preselect function. This mode allows the pilot to program into the AFCS a fixed vertical speed (typically in feet per minute) for the aircraft to climb or descend at. As an aircraft climbs, its performance degrades due to reduction of air density which leads to reduced engine thrust, propeller efficiency, and wing efficiency. This is especially true for small, normally-aspirated piston aircraft that can lose more than 50% of their performance as they climb. As an example, it is possible for the pilot to input a vertical speed climb rate which is obtainable from sea level to about 5000 feet (ft.), but by 6000 ft., the aircraft may be unable to maintain that climb rate.

To maintain the climb rate as aircraft performance decreases, a traditional low-cost AFCS will increase aircraft pitch. If the programmed climb rate is not achievable, the AFCS will continue to increase the pitch attitude of the aircraft. This will result in a reduction of airspeed and an increase in angle of attack. If the angle of attack becomes too large, the aircraft wing will stall. When the aircraft stalls, the aircraft may depart controlled flight. In the worst case, this could cause the aircraft to enter an unrecoverable stall or spin and crash. This is a common operational problem with small aircraft and low-cost autopilots. The pilot is thus required to monitor the autopilot to prevent the inadvertent stall.

It should be appreciated that at least some of the foregoing problems have been addressed on large aircraft with advanced Flight Management Systems (FMS) functions including Performance Estimation and Monitoring Software. However, these systems typically include aircraft-specific certification, which is costly and time consuming.

Accordingly, there remains a need in the art for improved AFCS technologies, especially those that include a vertical speed mode. In particular, it would be desirable to provide an AFCS with a vertical speed mode that will not increase the pitch of the aircraft to stall as climb performance degrades with increasing altitude. It would further be desirable to provide such systems that do not require constant pilot attention of the autopilot to prevent an inadvertent stall condition. Moreover, it would be desirable to provide such systems that do not require aircraft-specific certification. Furthermore, other desirable features and characteristics of the disclosure will become apparent from the subsequent detailed description and the appended claims, taken in conjunction with the accompanying drawings and this background of the disclosure.

### BRIEF SUMMARY

The present disclosure relates to AFCS technologies with altitude-based, automatically-adjusting rate of climb algorithms and controls. In one exemplary embodiment, a method of automatically controlling the vertical speed of an aircraft during a climb from a first altitude to a second altitude greater than the first altitude includes the steps of: at an AFCS, receiving an input to climb to the second altitude at a first vertical speed; based on the input, sending an electronic signal from the AFCS to a mechanical servo of the aircraft to cause the aircraft to climb at the first vertical speed; at the AFCS, automatically and without user input, determining a threshold altitude based on pre-loaded tabular data, wherein the threshold altitude is above the first altitude but below the second altitude, and further determining a reduced vertical speed associated with the threshold altitude, wherein the reduced vertical speed is less than the first vertical speed; at the AFCS, automatically and electronically monitoring the altitude of the aircraft as is climbs at the first vertical speed from the first altitude towards the threshold altitude, wherein said monitoring is performed using a barometric pressure-based altitude sensor; and upon reaching the threshold altitude, at the AFCS panel, automatically and without user input, sending an electronic signal from the AFCS to the mechanical servo of the aircraft to cause the aircraft to climb at the reduced vertical speed.

In another exemplary embodiment, disclosed is an automated flight control system (AFCS) that automatically controls the vertical speed of an aircraft during a climb from a first altitude to a second altitude greater than the first altitude. The AFCS is configured to: receive an input to climb to the second altitude at a first vertical speed; based on the input, send an electronic signal from the AFCS to a mechanical servo of the aircraft to cause the aircraft to climb at the first vertical speed; automatically and without user input, determine a threshold altitude based on pre-loaded tabular data, wherein the threshold altitude is above the first altitude but below the second altitude, and further determine a reduced vertical speed associated with the threshold altitude, wherein the reduced vertical speed is less than the first vertical speed; automatically and electronically monitor the altitude of the aircraft as is climbs at the first vertical speed from the first altitude towards the threshold altitude, wherein said monitoring is performed using a barometric pressure-based altitude sensor or external aircraft altimeter or air data computer; and upon reaching the threshold altitude, automatically and without user input, send an electronic signal from the AFCS to the mechanical servo of the aircraft to cause the aircraft to climb at the reduced vertical speed.

This brief summary is provided to describe select concepts in a simplified form that are further described in the detailed description. This brief summary is not intended to identify key or essential features of the claimed subject matter, nor is it intended to be used as an aid in determining the scope of the claimed subject matter.

### BRIEF DESCRIPTION OF THE DRAWINGS

The present disclosure will hereinafter be described in conjunction with the following drawing figures, wherein like numerals denote like elements, and wherein:

FIG. 1 is a block diagram of an automated flight control system (AFCS) suitable for use in an aircraft in accordance with the exemplary embodiments described herein; and

FIGS. 2A-2C are illustrations of AFCS panels, based on the system shown in FIG. 1, implemented in an aircraft that are operating under various controlled flight scenarios.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to navigation, flight planning, aircraft controls, aircraft data communication systems, and other functional aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

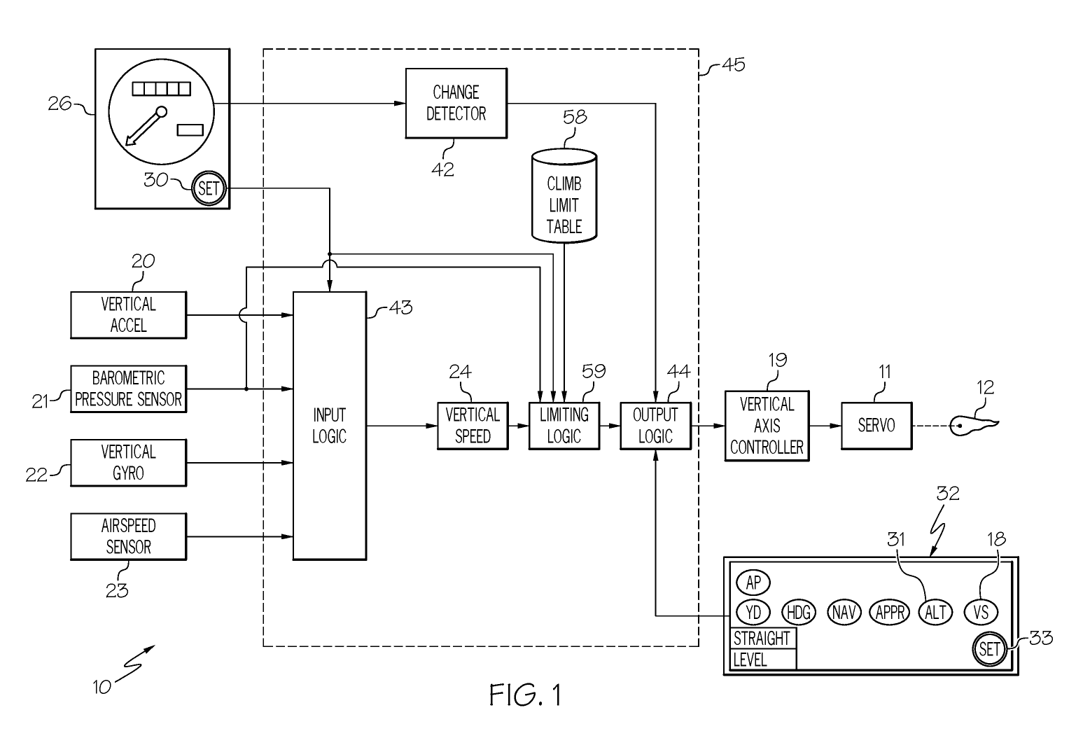

The following description refers to elements or nodes or features being “coupled” or “connected” together, in particular with regard to the exemplary AFCS shown in FIG. 1. As used herein, unless expressly stated otherwise, “coupled” or “connected” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

The present disclosure relates to AFCS technologies with altitude-based, automatically-adjusting rate of climb algorithms and controls. In some embodiments, the disclosed automated flight control system (the “system”) may monitor the aircraft altitude during a system-controlled climb and may reduce the climb rate automatically as the aircraft passes through specific, predefined altitude ranges. This automatic reduction in climb rate is provided to ensure that the aircraft does not increase its pitch attitude to the point of stall. Accordingly, the system uses a different approach from other, higher cost autopilots, which may use sensor inputs from angle-of-attack (AoA) or stall computer systems to prevent an inadvertent stall.

In some embodiments, the system may be implemented in the AFCS as a table of altitudes and maximum vertical speeds, herein referred to as pre-loaded tabular data. This table can be input by the pilot, or by the installer of the AFCS, based on the known performance of the aircraft (which varies from one aircraft type to another). An example of such a table (TABLE 1) is shown below, with regard to a hypothetical aircraft:

TABLE 1

| Altitude Maximum (ft.) | Vertical Speed (ft. per minute (fpm)) |
|---|---|
| 0-5000 | 1000 |
| 5000-7000 | 750 |
| 7000-9000 | 600 |
| 9000-11000 | 500 |

In some embodiments, when the vertical speed mode of the AFCS is active during the climb, the altitude-based, automatically-adjustable rate of climb feature may be activated by the pilot. Alternatively, it may be automatically activated (i.e., with no pilot action). The AFCS may then annunciate when the feature is engaged and the pilot will retain the ability to override the system table. It is not necessary that the system table be part of the certification basis of the aircraft or avionics—the table may be created by the aircraft owner or operator based on current conditions (outside air temperature, aircraft weight) as well as the owner or operator's desired margin of safety from inadvertent stall.

Referring now to FIG. 1, disclosed is a block diagram of one embodiment of the AFCS of the present disclosure, as well as its relation to other existing flight control systems (altimeter, other sensors, etc.). The automated flight control system 10 provides servo control of the aircraft's vertical axis or vertical flight path through control servo 11 and the control surface (elevator) 12. The automated flight control system may preferably be of the type offering a variety of path control modes selectable by the pilot, those of which not pertaining to vertical path control are not discussed herein in detail. The AFCS may be activated and controlled by a digital panel 32, which includes a vertical speed selector 18 for producing a command signal to the flight control system's vertical axis controller 19 to produce a climb or descent at a rate selected by the pilot, or as prescribed by the Table of maximum altitudes and vertical speeds, as shown above.

In an embodiment, the vertical axis controller 19 relies on the output of an altitude sensor or barometric pressure sensor 21 to provide dynamic altitude information. In other embodiments, altitude may be determined using an external aircraft altimeter or an air data computer Typically this sensor is quite sensitive to slight changes in barometric pressure; thus, it is said to have good resolution, and is well suited for use in an altitude hold, closed loop control circuit. In some embodiments, the output from the barometric pressure sensor 21, together with an output from a vertical accelerometer 20 are applied through input logic 43 to determine the aircraft's vertical speed 24 or its rate of climb or descent. Also applied to conversion circuitry 43 are pitch signals from a vertical gyroscope 22 and an airspeed signal from airspeed sensor 23. An altimeter 26, packaged separately, is usually not considered part of the automated flight control system. The altimeter is furnished with a manually operable readout adjustment knob 30 for adjusting the altitude reading displayed in the cockpit.

The altitude preselect apparatus of the present disclosure within the block outlined by broken lines in FIG. 1 (block 45), may be implemented using digital or analog circuitry and would normally be included as part of the flight control system's package. The altitude preselect and vertical speed control functions are operated via control panel 32, with operable selector knob 33 with which the pilot can select a desired flying altitude and/or vertical speed. The control panel 32 provides an electrical signal representing the pilot's desired altitude and vertical speed, and also includes the Table of maximum altitudes and vertical speeds, and also includes a visual for indicating the selected altitude and vertical speed. Data from the climb limit table 58 is applied to limiting logic 59, along with aircraft altitude from either the altimeter 26 or the barometric pressure sensor 21, or both. If the aircraft crosses a predefined altitude in the climb limit table 58, the limiting logic 59 reduces the vertical speed 24 before applying it to output logic 44. Output logic 44 is connected to receive the signal from the panel 32, as well as the limited vertical speed from logic 59, to provide an appropriate command to the vertical axis controller 19. In some embodiments, an altitude change detector 42, connected with the altimeter 26, also provides an altitude rate of change signal to the output logic 44.

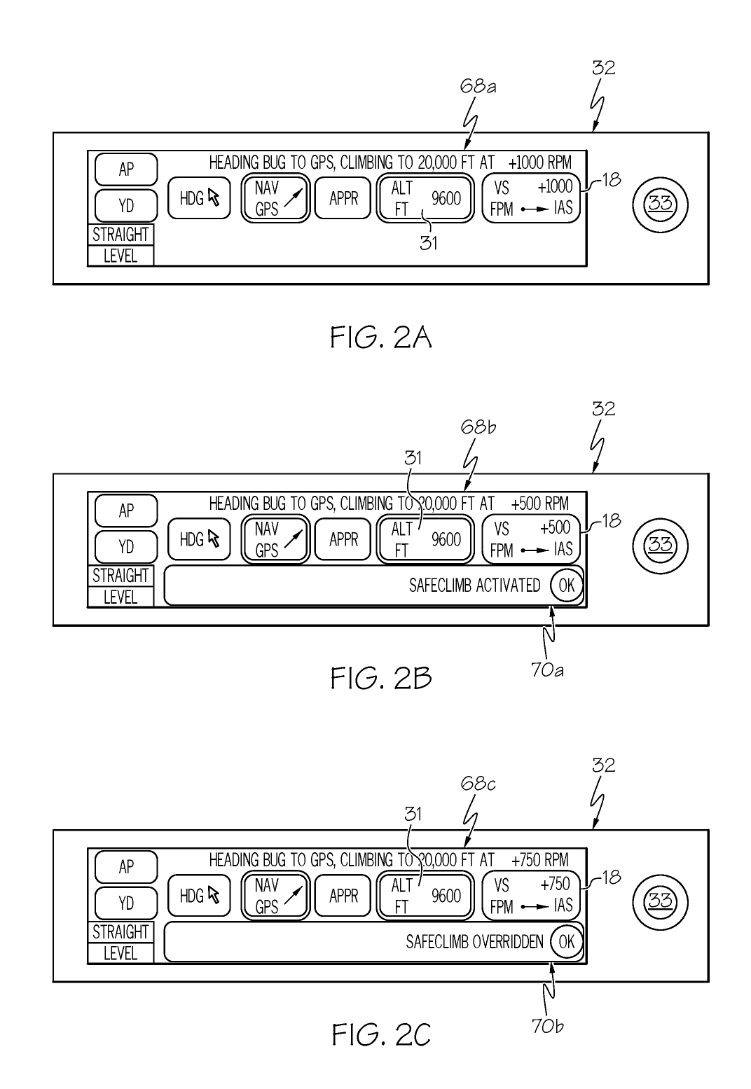

FIGS. 2A-2C are illustrations of AFCS panels 32, based on the system shown in FIG. 1, implemented in an aircraft that are operating under various controlled flight scenarios. As shown in FIG. 2A, the aircraft is in a vertical-speed controlled climb of 1000 fpm (18), and is currently at 9600 ft. (31). A message area 68a may indicate the altitude to which the aircraft is climbing (20,000 ft.), and its rate of climb (1000 fpm). Referring now to FIG. 2B, assuming that a Table boundary is 9,600 ft., the panel 32 now shows that the system has automatically (and without input from the pilot) reduced the rate of climb to 500 fpm. Message area 68b now indicates the new rate of climb, as per the Table. A message area 70a indicates that the altitude-based, automatically-adjusting rate of climb algorithms and controls have been activated. Further, as shown in FIG. 2C, the pilot may override the altitude-based, automatically-adjusting rate of climb algorithms and controls in order to change the vertical speed to a different setting, in this case an increase to 750 fpm, as indicated in message area 68c. Further, message area 70b indicates that the system has been overridden.

As per FIGS. 2A-2C, in some embodiments, when a Table boundary is crossed, the vertical speed shown in message area 68 may flash, change color, or otherwise change from its normal display status. This indicates that the system is changing the vertical speed as per the Table requirements. If, as per FIG. 2C, a pilot enters a vertical speed target above the Table boundary, message area 68 may flash, change color, or otherwise change from its normal display status. The system accepts the pilot's entry regardless, and in this case, the automatically-adjusting vertical speed protocols are disengaged. An aural warning may also be included, in some embodiments, for any of the foregoing commands.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of automatically controlling the vertical speed of an aircraft during a climb from a first altitude to a second altitude greater than the first altitude, the method comprising the steps of:
at an automated flight control system (AFCS), receiving an input to climb to the second altitude at a first vertical speed;
based on the input, sending an electronic signal from the AFCS to a mechanical servo of the aircraft to cause the aircraft to climb at the first vertical speed;
at the AFCS, automatically and without user input, determining a threshold altitude based on pre-loaded tabular data, wherein the threshold altitude is above the first altitude but below the second altitude, and further determining a reduced vertical speed associated with the threshold altitude, wherein the reduced vertical speed is less than the first vertical speed;
at the AFCS, automatically and electronically monitoring the altitude of the aircraft as is climbs at the first vertical speed from the first altitude towards the threshold altitude, wherein said monitoring is performed using a barometric pressure-based altitude sensor or external aircraft altimeter or air data computer; and
upon reaching the threshold altitude, at the AFCS, automatically and without user input, sending an electronic signal from the AFCS to the mechanical servo of the aircraft to cause the aircraft to climb at the reduced vertical speed.

2. The method of claim 1, wherein the pre-loaded tabular data is loaded into the AFCS by a pilot of the aircraft.

3. The method of claim 1, wherein the pre-loaded tabular data is loaded in to the AFCS by an installer of the AFCS.

4. The method of claim 1, wherein the aircraft comprises a normally-aspirated piston aircraft.

5. The method of claim 1, wherein the pre-loaded tabular data comprises one or more additional threshold altitudes, along with one or more further reduced vertical speeds corresponding to each of the one or more additional threshold altitudes.

6. The method of claim 5, further comprising monitoring for the one or more additional threshold altitudes, and, upon reaching such one or more additional threshold altitudes, further reducing the vertical speed of the aircraft.

7. The method of claim 1, wherein the pre-loaded tabular data is selected with altitude and vertical speed values to prevent an aerodynamic stall of the aircraft.

8. The method of claim 1, wherein the user retains the ability to override any automated actions of the AFCS.

9. The method of claim 1, wherein the AFCS comprises an aural or visual indication that a vertical speed mode is activated.

10. The method of claim 1, wherein the mechanical servo is coupled with a horizontal flight control surface of the aircraft.

11. An automated flight control system (AFCS) that automatically controls the vertical speed of an aircraft during a climb from a first altitude to a second altitude greater than the first altitude, wherein the AFCS is configured to:
receive an input to climb to the second altitude at a first vertical speed;
based on the input, send an electronic signal from the AFCS to a mechanical servo of the aircraft to cause the aircraft to climb at the first vertical speed;
automatically and without user input, determine a threshold altitude based on pre-loaded tabular data, wherein the threshold altitude is above the first altitude but below the second altitude, and further determine a reduced vertical speed associated with the threshold altitude, wherein the reduced vertical speed is less than the first vertical speed;
automatically and electronically monitor the altitude of the aircraft as is climbs at the first vertical speed from the first altitude towards the threshold altitude, wherein said monitoring is performed using a barometric pressure-based altitude sensor or external aircraft altimeter or air data computer; and
upon reaching the threshold altitude, automatically and without user input, send an electronic signal from the AFCS to the mechanical servo of the aircraft to cause the aircraft to climb at the reduced vertical speed.

12. The AFCS of claim 11, wherein the pre-loaded tabular data is loaded into the AFCS by a pilot of the aircraft.

13. The AFCS of claim 11, wherein the pre-loaded tabular data is loaded in to the AFCS by an installer of the AFCS.

14. The AFCS of claim 11, wherein the aircraft comprises a normally-aspirated piston aircraft.

15. The AFCS of claim 11, wherein the pre-loaded tabular data comprises one or more additional threshold altitudes, along with one or more further reduced vertical speeds corresponding to each of the one or more additional threshold altitudes.

16. The AFCS of claim 15, wherein the AFCS is further configured to monitor for the one or more additional threshold altitudes, and, upon reaching such one or more additional threshold altitudes, to further reduce the vertical speed of the aircraft.

17. The AFCS of claim 11, wherein the pre-loaded tabular data is selected with altitude and vertical speed values to prevent an aerodynamic stall of the aircraft.

18. The AFCS of claim 11, wherein the user retains the ability to override any automated actions of the AFCS.

19. The AFCS of claim 11, wherein the AFCS comprises an aural or visual indication that a vertical speed mode is activated.

20. The AFCS of claim 11, wherein the mechanical servo is coupled with a horizontal flight control surface of the aircraft.
